(19) United States
(12) Patent Application Publication
(10) Pub. No.: US 2008/0319864 A1
(43) Pub. Date: Dec. 25, 2008

(54) Method of dynamically routing food items through a restaurant kitchen

(75) Inventor: Lee Leet, Louisville, KY (US)

Correspondence Address: H. JAY SPIEGEL - H. JAY SPIEGEL & ASSOCIATES, P.O. BOX 11, MOUNT VERNON, VA, 22121, US

(73) Assignee: QSR AUTOMATIONS, INC.

(21) Appl. No.: 11/812,685

(22) Filed: Jun. 21, 2007

(51) Int. Cl. G06Q 50/00

(52) U.S. Cl. 705/15; 99/486

(57) ABSTRACT

Dynamic Routing of food items through a restaurant kitchen improves on advanced routing methods by being forward looking and forecasting the time to prepare each of the menu items within an order based on the current capacity and conditions of individual prep stations. Such Dynamic Routing has the ability to monitor for current status on a user defined basis, updating forecasted times based on real-time factors that can impact these forecasted times. The method improves on advanced routing methods by keeping track of the status of each and every individual item within an order as it goes through the preparation process. Therefore, if one item gets behind or one prep station that is responsible for an item on that particular order gets behind, the remaining items do not commence to the prep stations, keeping the balance of the order on track for all items to complete the preparation process at the same time. Overall, the present invention encompasses every facet of the preparation process and every factor that can impact that preparation process, using advanced logic and algorithms to continuously forecast and adjust forecasted times at a very granular menu item level to protect workflow, labor efficiency, and food quality.

### BACKGROUND OF THE INVENTION

The present invention relates to a method of dynamically routing food items through a restaurant kitchen. The present invention is best understood in the context of Applicants' Assignee's hospitality and restaurant management software packages that are well known and successfully used in the marketplace at this time. The present invention comprises a business method for altering the flow of food items that have been ordered by customers as they are routed through a restaurant kitchen to better coordinate the timing and kitchen execution to ensure that meals are prepared efficiently with all of their components being completed at nearly the same time while protecting a healthy workload for the kitchen personnel.

QSR's ConnectSmart® Hospitality Automation Solution offers sophisticated technology to automate the toughest areas in the hospitality business, those not managed by point-of-sale or back office systems. The open, standards-based software and hardware solution provides rich feature sets and high reliability with the added benefits of graphical capabilities and multi-media functionality.

The completely integrated, fully customizable ConnectSmart applications include the ConnectSmart Hostess (CSH) for complete table management and sophisticated ConnectSmart Kitchen (CSK) for advanced kitchen automation. Within the ConnectSmart hardware portfolio are the durable KP-3000 keypad, powerful eXpert® hospitality controller, and all-in-one eXpertONE™ hospitality system.

QSR's ConnectSmart Hospitality Automation Solution enables hospitality companies to achieve their business goals by aligning staff efforts within and between all front-of-house and back-of-house activities. With the ConnectSmart solution, operators gain access to centralized data and end to end service timing while managing and capturing the total guest experience. From configurable graphical software to purpose-built multi-media hardware, the ConnectSmart solution intelligently connects hospitality businesses around the world to measurable, high quality service for maximum guest delight.

The ConnectSmart Kitchen (CSK) graphical software measurably increases efficiency and quality, enabling hospitality companies to create positive guest experiences each and every visit. An innovative tool for sophisticated kitchen automation, the CSK offers fully customizable views at each kitchen station with enhanced order and item details. While providing significant benefits to the table service market, the CSK offers robust features to answer the needs of all concepts—including quick service, fast casual, deli, bar, concession, pizza, delivery, and other unique environments.

And to ensure that QSR's customers can benefit from QSR's solutions no matter which point-of-sale system they choose to use, the CSK is tightly integrated and successfully installed with many leading systems. QSR's software is open and reliable, with a real-time event-driven architecture. Their applications are configured and maintained through easy-to-use management tools. And, making real-time configuration changes is easy.

The added benefits of graphical capabilities enable hospitality operators to make use of menu cards as well as the visual cues that are most meaningful within their specific environment. With graphical kitchen views and menu cards, operators can further enhance accuracy, labor efficiency, and training—ultimately maximizing productivity, profit, and guest delight.

Taking advantage of specific colors and fonts that are well known within the operator's environment, each kitchen station view can be fully customized, including the display attributes of every item, item status, order, and order status. Adding to the flexibility of the CSK, the use of different sized fonts can call attention to specific details, or increase the amount of information presented within certain areas of a kitchen view. While helping maximize precious real estate, fonts and colors ensure that important information is not missed.

And with the ability to dynamically display menu cards, operators can easily introduce new products and personnel, ensuring consistency for guests with minimal training effort. Intuitive and interactive, menu cards provide kitchen staff with recipe information when and where it is needed with the push of a keypad or touchscreen button. Operators are no longer required to print, distribute, or hang recipe information, cutting down on cost and clutter. The innovative CSK also supports animated menu cards for items requiring special plating.

The CSK is highly configurable, built around the concept of virtual views. A virtual view is a logical display of items or orders that have a common routing scheme. For each virtual view, specific routing instructions are configured, driving the items or orders to the correct virtual view. In addition to routing instructions, a keypad is also associated with each virtual view (unless the operator chooses to use a touch screen monitor), and functions must be assigned to that keypad.

With the CSK's graphical capabilities, order views can be configured in more than ninety different ways, while item views are only limited based on the font size defined by the user. Additionally, users can manage more than one kitchen function within a single screen, splitting views at thirty, forty, or fifty percent and customizing each portion of the screen with different routing and display instructions.

QSR pioneered kitchen automation for the table service industry with the creation of Delay Routing, and the ability to route and interact at the individual item level with the Item View (FIG. 1). Based on the configuration, each line on the Item View can include the line number, table number or transaction number, main item, sub-items, and item display timer or order timer. And, based on customizable font sizes, operators can choose to display as few or as many items as fits their needs on each Item View.

With the Item View, individual items are routed to the specific kitchen station where they are prepared, enabling each prep station to focus only on those items that it is responsible for. For instance, grill items will be routed to the grill station, while bake items will be routed to the bake station. While individual items are routed to specific stations, the expeditor station receives all of the items for an order in an Order View. As items change status on the Item Views throughout the preparation process—getting cooked and then finally prepared—each change to each item on each prep station is reflected on the order at the expo station. This makes it easy for staff and management to check status from anywhere on the floor with just a glance to the expo view.

Using the Item View, restaurant operators can ensure that food standards are met by routing items as they move through the kitchen, and displaying timers for kitchen staff to view at a number of stations. Using Item Views also allows the tracking of cook times based on individual items.

While most often used in table service, any hospitality company with the need to view and manage individual items, such as bars and coffee shops, can benefit from the unique Item view.

The Order View (FIG. 2) is a static layout routing and displaying at the order level, with orders populating the screen grid by grid. For large orders, items may be continued in the grid to the right of the originating grid. When the number of orders exceeds the number of grids, the new orders are placed into a scroll queue, denoted by arrows in the upper right and left hand sides of the screen. With the Order View, operators can track service times at the order level.

With the CSK's graphical and functional capabilities, operators can create a number of configurations, such as: 4 by 2, 4 by 1, 5 by 3, 6 by 2, 6 by 3, etc. For example, a table service operator may choose to use a 4 by 2 Order View for its expeditor station, enabling runners to see the status of up to eight orders at a time. However, that same operator may choose to rely on a 5 by 3 view during the hectic lunch period, because history has shown that most orders are two-person orders, and therefore take up a smaller amount of space on the screen. This enables more orders to fit on one screen at one time.

Also powered by the ability to use different font sizes, operators can choose up to six columns and three rows while also splitting views at thirty, forty, or fifty percent—making more than ninety different customizable options available.

Not only can operators of the CSK software configure a view that routes and displays menu items and orders in a specific manner at each individual station within the kitchen—operators can split the screens, driving and displaying information in a unique manner for each specific virtual view within that same monitor. See FIG. 3.

To share a screen for managing more than one kitchen function, operators can choose to split a station view into, for example, a 30/70 or 40/60 or 50/50 split, customizing each portion of the screen with different routing and display instructions. This includes a combination of Item Views and Order Views. This flexibility makes the CSK a fit for hospitality companies of all sizes and concepts, and multi-concepts.

For example, during non-peak periods, one station may be used for both carry-out and eat-in orders. For this configuration, a 6 by 1 view can be used in the top half of the screen for eat-in orders, and a 4 by 1 in the bottom half of the screen for carry-out orders.

With the ability to dynamically display graphical menu cards (FIG. 4), operators can easily introduce new products and personnel, ensuring quality and consistency for guests with minimal training effort. This powerful tool provides kitchen staff the information they need without costly and involved training sessions.

Intuitive and interactive, menu cards provide kitchen staff with critical information when and where it is needed with the push of a keypad button. Operators are no longer required to print, distribute, or hang recipe information, cutting down on costs and clutter.

The CSK also supports animated menu cards for items requiring special plating.

Each item or item status and order or order status can carry its own display attributes, which are used in many different ways by the CSK. Every item has a cook time, item priority, new time, priority time, and rush time—and each item or item status may also have specific color attributes assigned. Cook times are used by routing logic, and priority values are used for item and order sorting. The new, priority, and rush times are used to indicate status changes and/or to generate alerts.

Activity Levels enable the CSK to operate differently as store conditions change throughout the day or week. As the number of kitchen staff or stations required to keep up with volumes experience changes during the day or week, the configuration of the CSK can also be changed to ensure maximum efficiency.

For example, the lunch rush period has different demands than the dinner rush. Using Activity Levels, operators can easily change the kitchen configuration to be suited to each of these different periods. Each Activity Level contains its own set of virtual views, with each view complete with routing schemes and virtual keypads assigned to it. Activity Levels can be changed on the fly, modifying the operation of the CSK without disrupting critical operations or loosing orders.

The CSK supports up to sixteen Activity Levels for each database, and up to thirty-two independent routing schemes for each Activity Level. Each Activity Level also supports up to thirty-two virtual keypads.

Orders can be configured to display based on chronological order (first-in, first-displayed), or to display priority orders first—determined by the item within the order that has the highest item priority value.

There are also many sorting options for items and sub-items within each order on the station views. Additionally, the CSK has the ability to sort on the prepared order status, sending prepared orders to the front of the Order View (or expeditor). This is extremely beneficial for ensuring that prepared orders are immediately delivered to waiting customers, which helps reduce average order times.

In addition to bumping orders and items from a specific view, orders and items can be bumped across multiple views, and can be bumped to other kitchen views. On the same concept as the virtual view, a virtual keypad is a logical grouping of keys on a single physical keypad. When configuring the virtual keypad, the operator can configure all twenty keys, or just some of the keys. Powered by the ethernet network of the solution, a virtual view may be assigned more than one virtual keypad—and a virtual keypad may be assigned to more than one virtual view.

For instance, virtual keypads allow users to control a single view from a single keypad, or control multiple views within one screen, or across many screens from the same keypad. And, a single push of a key may generate multiple user-defined functions, such as bump an item from all prep stations. This is useful for slower periods when an operator may choose to route items to more than one prep station, because only one cook is manning all of the stations. This enables the cook to bump the item from anywhere in the kitchen and remove it from all of the views.

As another example, there may be a screen that is split between two virtual views—one view on the top half of the screen and the other on the bottom half. The operator may want each virtual view to have its own separate controls, and also wants these controls to be located on the same virtual keypad. The virtual keypad can be configured to have the top half—or top ten keys—control the view on the top half of the screen, and the bottom half—the other ten keys—to control the view on the bottom half of the screen.

Also, completed orders may be bumped to a printer (or a “Print” button can be configured on the keypad), initiating a receipt to print. In a table service environment, this receipt depicts seat assignments for that order, so that the runner knows which item belongs to which person at the table—avoiding the auctioning of food.

With the CSK, operators have virtually unlimited routing choices. Operators can choose traditional routing options, such as routing based on terminal ID number, destination, or item category. Routing can also be set up based on item exceptions—or based on specific user-defined routing rules.

Rules-based routing further expands the robust routing capabilities of the CSK. With rules-based routing, items can be routed based on additional criteria, such as item types and terminal groups, and based on conditional statements.

With delay routing, each menu item is assigned a cook time (either from the point-of-sale, or within the CSK). When an order is placed that contains multiple menu items, the item with the longest cook time is routed to the appropriate kitchen station first. With the system keeping track of the first item as it is cooking, the next item is then routed based on its cook time to its appropriate prep station—and so on, until all items on the order are cooking such that they are targeted to complete at the same time. This helps ensure that all items are served hot and fresh to customers—and that the expeditor counter is not overloaded with items that are put under a heat lamp while waiting on other items to complete. Delay routing also removes the burden from the kitchen staff of figuring out when to cook which items.

Assigning cook times in the CSK is easy, if they are not already determined by the point-of-sale. The CSK can also account for modifiers, such as rare and well done, by assigning percentages to standard cook times (where rare is 80% of the standard cook time, and well done is 110%).

Operators can also choose to show items in a preview mode with countdown timers, giving the kitchen staff opportunity to prepare for coming items. A tone can be sounded—alohg with changing display attributes, like color—when the item changes from Preview mode to Active mode.

Often a key to maximizing efficiency, the load balancing functionality within the CSK separates the workload between two or more virtual views for any items or specific groups of items in order to optimize the work distribution in the kitchen and preparation area.

At the order level, load balancing can be done based on the number of orders, or the number of items within the orders. At the item level, the work load can be distributed by the total number of items being routed to each view, or distributed based on the cook times of the items. Unique to the CSK, load balancing can be added to any established routing scheme with the simple click of a mouse on a check box within the CSK Builder Pro, making the configuration of this powerful feature extremely flexible.

The kitchen is mission critical to the operation of the restaurant, and operators cannot afford for any down time. In addition to the high reliability of QSR's solutions, the CSK provides added features to handle situations automatically, should a system failure occur. With unmatched redundancy, the CSK can be configured to automatically send the routing of items or orders that would normally go to a down device, to a backup device. And if one station experiences an outage, only that station is affected.

The CSK system is an open, XML-based, 32-bit solution that offers easy integration with store systems used within the enterprise. Most importantly, the ConnectSmart solution architecture ensures hospitality businesses can take advantage of service metrics that are centered around the guest.

QSR's ConnectSmart BackOffice provides an architecture that is optimized for performance and efficiency in support of all of the robust ConnectSmart applications, including the CSK. Housed and efficiently organized within one central location—the ConnectSmart BackOffice—are the transaction manager, data directories, runtime executables, and configuration tools for each of the ConnectSmart applications. This scheme also creates the added advantage of easy data maintenance and distribution of software updates across remote locations. In addition to the ConnectSmart BackOffice, QSR's QSRnet middleware enables the CSK to consistently and easily receive and transmit messages to all third party applications within the in-store network, including the point-of-sale and backoffice systems. The powerful combination of QSR's CorinectSmart BackOffice, QSRnet, and the CSK's open, XML-based architecture enables transactional data to be meaningfully captured, compared, and used to enhance productivity.

The CSK's open architecture ensures transactional data can be meaningfully captured, compared to other store data, and used by the operator to enhance productivity. With the CSK system, operators have access to speed of service production data in real-time and historical formats.

The CSK's event driven architecture gathers important item and transaction level data and events in real-time that can be used to improve speed and efficiency. This critical data includes a variety of speed of service timing information, as well as event notifications. Every time an order or an item is bumped from a view, a service timing record is created. Operators can track time stamps for information received by the CSK, as well as actions taken within the CSK, including bumped, tendered, and parked. These activities can be tracked at the order level or the item level as well as at the Activity Level, making it easy to take a snapshot of a specific daypart.

For real-time use of the speed of service data, virtual views can be configured to display the average speed of service time at the top of the screen. Highlighting opportunity areas quickly, the CSK displays average cook times at each Item View station and average order times at each Order View station. Additionally, for those restaurants that choose not to change Activity Levels—or may change cooks within an Activity Level—the speed of service time can be reset from the CSK Console at any time.

The CSK system also tracks and transmits item and order event messages, which contain specific information about an item or an order, such as the bumping and prepping data. These messages can be enabled or disabled within the CSK, and all information is available in real-time. There are more than twenty pre-configured events in the CSK, such as item bumped and unbumped, check bumped and unbumped, item cooking and prepared, check prepared, item and check new, item priority and rush, item and check cleared, and service timing. And, like the speed of service data, the events can be sent to the point-of-sale or to third party applications—and can also be sent to other station views.

And with its configurable speed of service file, the CSK system provides the critical operational information needed for each specific environment while simplifying daily maintenance. The operator can define the data organization, including what data to collect as well as how to store and archive the information. Additional flexibility includes the ability to exclude extreme values when tracking speed of service data, in order to avoid skewing the results. Operators can also configure the data record format, using logic that works with transactions across multiple courses or trays, as well as allowing the creation of a user-defined data record format to eliminate unnecessary fields.

With access to this important production information, hospitality companies can compare volumes and average times, as well as labor, revenue, and sales data to determine if sales are turning into profit or being eaten away by operational inefficiencies.

The CSK system helps table service operators enhance food quality and shave minutes off of their average ticket times, increasing table turns and guest satisfaction. The benefits of replacing kitchen printers also include reducing labor, consumables, and maintenance costs.

### SUMMARY OF THE INVENTION

The present invention relates to a method of dynamically routing food items through a restaurant kitchen. The present invention comprises an improvement over the delay routing procedure achieved by Applicants' Assignee's CSK system. The present invention enhances the efficiency and effectiveness when routing items and orders through a kitchen of a commercial restaurant.

The present invention includes the following interrelated objects, aspects and features:

(1) In a first aspect, Dynamic Routing in accordance with the teachings of the present invention enables the kitchen to work consistently to produce the maximum quality product as quickly and efficiently as possible. Such Dynamic Routing also reduces overload, which improves accuracy, quality, and in-store personnel satisfaction. Current functionality for the communication of cooking processes through a kitchen is typically managed by QSR's kitchen software with different routing schemes.

(2) Using Delay Routing as explained above, the kitchen software takes the order from the point-of-sale system, breaks the order into meal components (referred to as “items”), and communicates the preparation of each item to the specific kitchen station where those items are cooked/prepared (“prep station”). Items are routed intelligently only to the prep stations where they are prepared while the entire meal is displayed at an expediter station where orders are brought together before being served to the table.

(3) “Dynamic Routing” in accordance with the teachings of the present invention is an improvement over the Delay Routing of the CSK system, significantly improving on the timing of items throughout the preparation process to fully maximize labor efficiency and food quality. Delay Routing routes items to their appropriate prep stations based on their individual cook times so that all items are targeted to complete the preparation process at the same time. Dynamic Routing works in conjunction with Delay Routing, taking Delay Routing further in three distinct ways as follows:
a) First, Delay Routing automatically routes the first item on the order to its prep station as soon as the server enters the order in the point-of-sale system. By contrast, Dynamic Routing will not commence the first item in the sequence if any of the individual prep stations that are responsible for preparing an item on that order is behind schedule. Dynamic Routing will begin the routing process for that order when the timing is correct for all items to be completed at the same time. Dynamic Routing will first check the status of each of the prep stations involved in that order to ensure that each prep station is capable of completing the preparation of the item as expected. If any prep station is behind schedule, then Dynamic Routing will wait to fire the first item until all prep stations are capable of handling the items as expected, so that all items on the order will complete at the same time. Therefore, Dynamic Routing can completely hold orders, waiting to route all items on the order, if a single prep station that is involved in the preparation of an item on that order is behind. Delay Routing cannot accomplish this feat.
b) Second, Dynamic Routing includes constant monitoring of the system (based on user-defined intervals, such as every 30 seconds or every 5 minutes) to determine and adjust forecasted times. These forecasted times take into account the cook times of items as defined in a resident database along with the factors that impact these cook times. Dynamic Routing then applies logic behind each of these factors to forecast a more accurate time to completion for each item. Dynamic Routing uses these forecasted times as it commences preparation of each item within the sequence for the order. These factors may include bottlenecks in the prep stations, which can be caused by environmental issues (such as equipment or personnel not working efficiently) as well as capacity of the prep stations (what each prep station is physically able to prepare at one time). In addition, labor can be a component used in this method where some prep stations may have a larger service capacity if more staffing, or more experienced staffing, is available. Dynamic Routing not only identifies these factors, but also determines how these factors should adjust forecasted times. To ensure accuracy, and to ensure that anomalies do not impact forecasting, Dynamic Routing relies on averages along with trends as well as user defined minimum and maximum deviations when making forecasting adjustments based on any factor.
c) Third, Delay Routing waits for the first item to be marked as cooking by the kitchen personnel actually manning the prep station before firing the second item. Then with Delay Routing, each item behind the second item fires off based on its cook time without a check to ensure the previous item has been marked as cooking. In addition to taking into consideration the forecasted times as discussed above, the operator of the Dynamic Routing method actually waits for each item to be marked as cooking by the kitchen personnel before considering firing off the next item. Dynamic Routing is constantly managing the process of commencing preparation of items until each item on that order has been commenced. Therefore, if any item within the order gets behind once the preparation process has begun for the items within a particular order, only the items previously commenced may be impacted—not those items that have yet to be started.

Accordingly, it is a first object of the present invention to provide a method of dynamically routing food items through a restaurant kitchen.

It is a further object of the present invention to provide such a method in which the status of each prep station involved in an order is checked prior to commencing cooking of a first item.

It is a still further object of the present invention to provide such a method in which orders can be completely held under circumstances where a single prep station involved in preparation of an item is behind schedule.

It is a still further object of the present invention to provide such a method in which the entire kitchen system is monitored periodically so that completed cooking items may be determined and continually adjusted.

It is a yet further object of the present invention to provide such a method in which forecasted times are used to begin preparation of each item within a pre-designed sequence for an order.

It is a still further object of the present invention to provide such a method in which when a first item has begun the cooking process, the inventive system is notified before even considering commencing cooking a second item.

These and other objects, aspects and features of the present invention will be better understood from the following detailed description of the preferred embodiment when read in conjunction with the appended drawing figures.

### BRIEF DESCRIPTION OF THE DRAWINGS

FIG. 1 shows a schematic representation of an item view display as displayed in Applicants' Assignee's prior art CSK system.

FIG. 2 shows a schematic representation of an order view display as displayed in Applicants' Assignee's prior art CSK system.

FIG. 3 shows a schematic representation of a split view display as displayed in Applicants' Assignee's prior art CSK system.

FIG. 4 shows a schematic representation of a menu card display as displayed in Applicants' Assignee's prior art CSK system.

FIG. 5 shows a flowchart of operation of steps 1-7 of the inventive method.

FIG. 6 shows a flowchart of steps 8-14 of the inventive method.

FIG. 7 shows a flowchart of steps 15-18 of the inventive method.

FIG. 8 shows further details concerning step 6 illustrated in FIG. 5.

FIG. 9 shows further details concerning step 7 illustrated in FIG. 5.

FIG. 10 shows further details concerning step 11 illustrated in FIG. 6.

FIG. 11 shows a chart showing ideal cook time in comparison to actual cook time taking into account actual cook time and cook delay time.

FIG. 12 shows a chart comparing ideal cook time with forecasted cook time in connection with an example of calculations made with the dynamic routing process of the present invention.

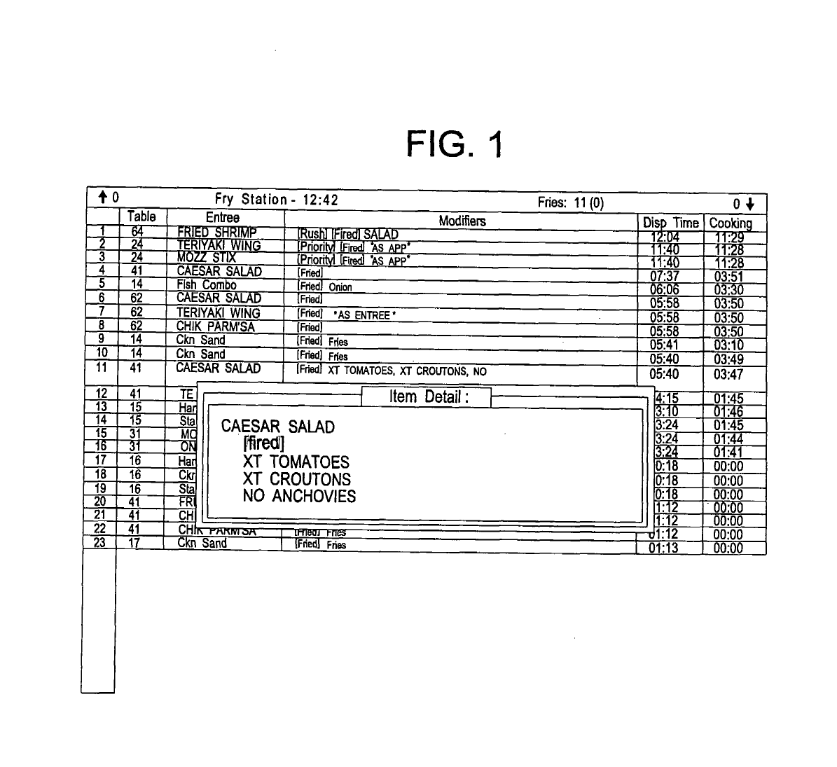

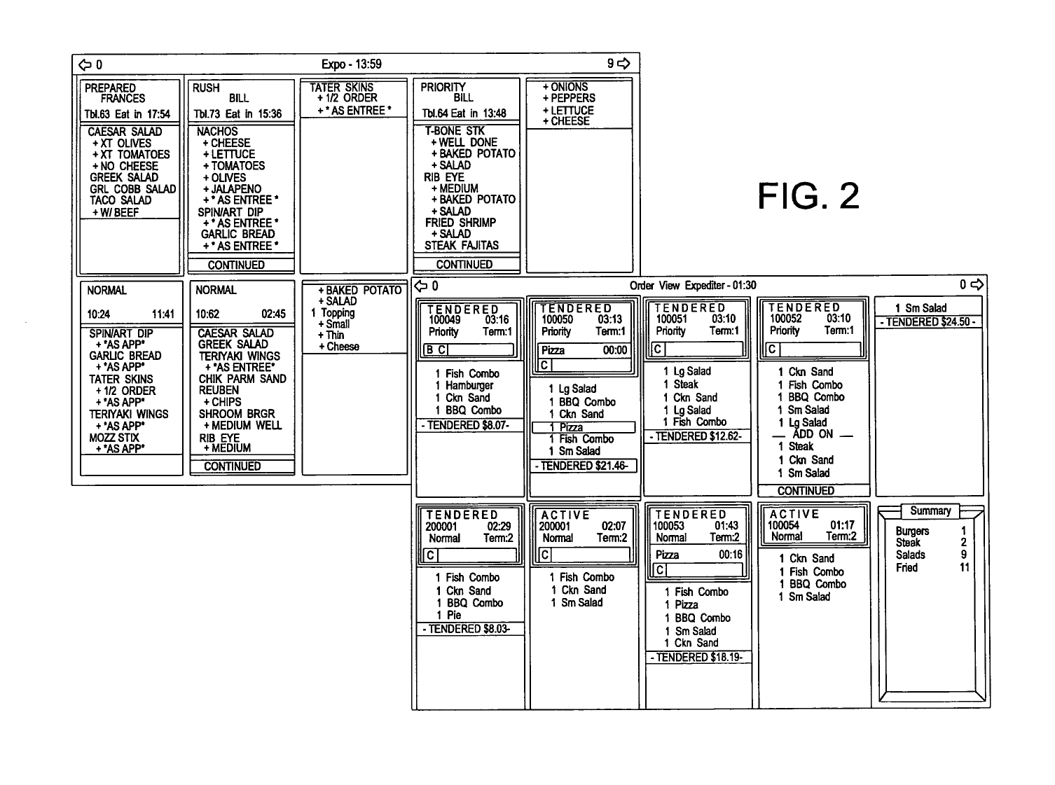

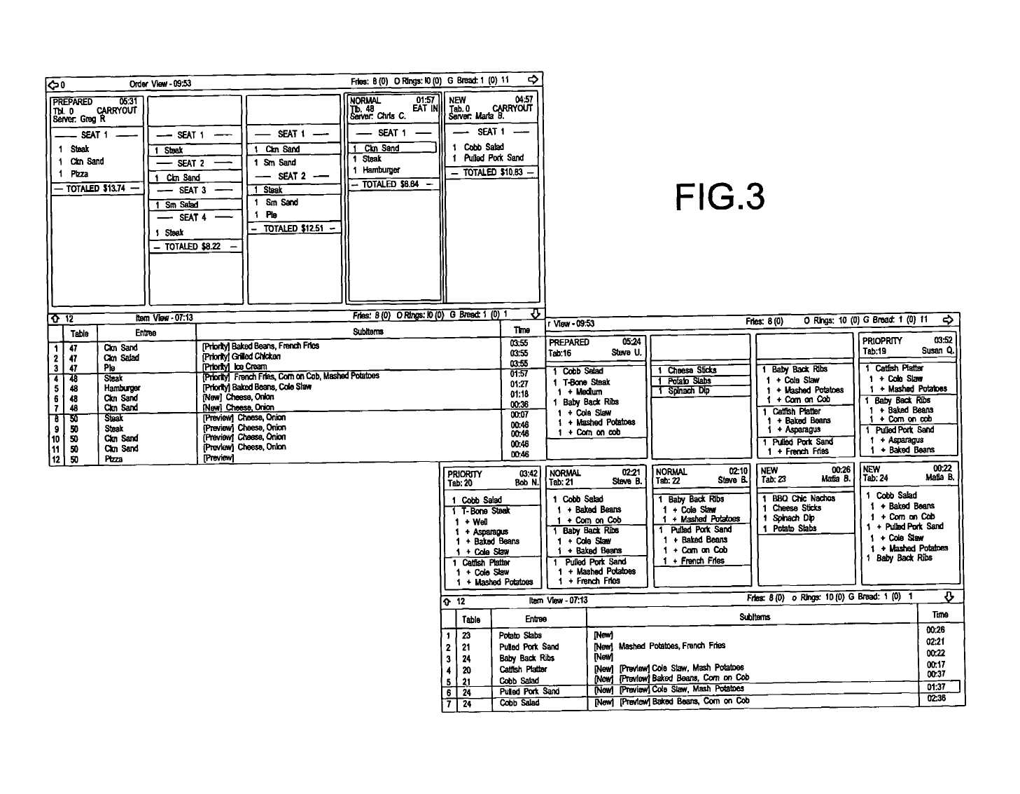

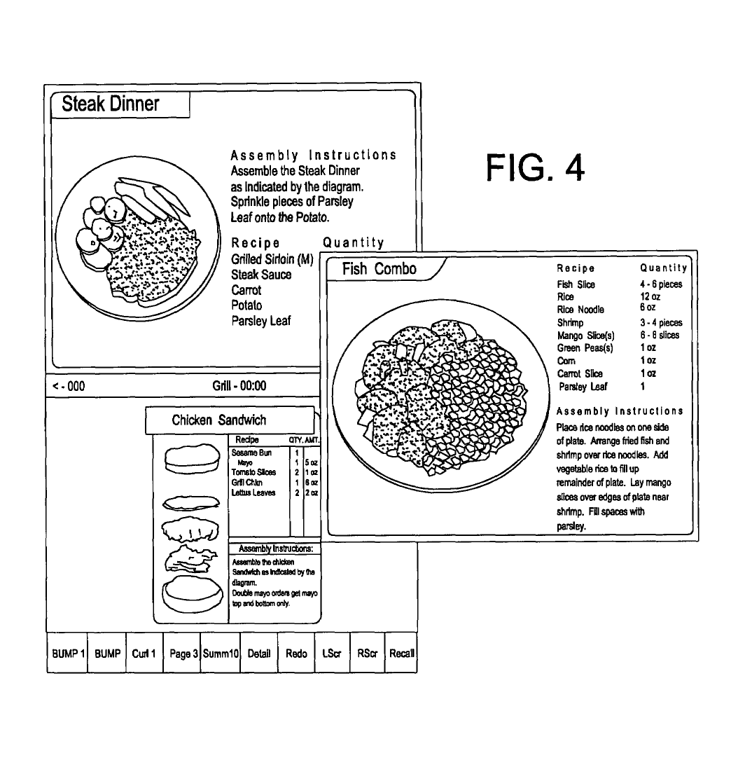

### SPECIFIC DESCRIPTION OF THE PREFERRED EMBODIMENT

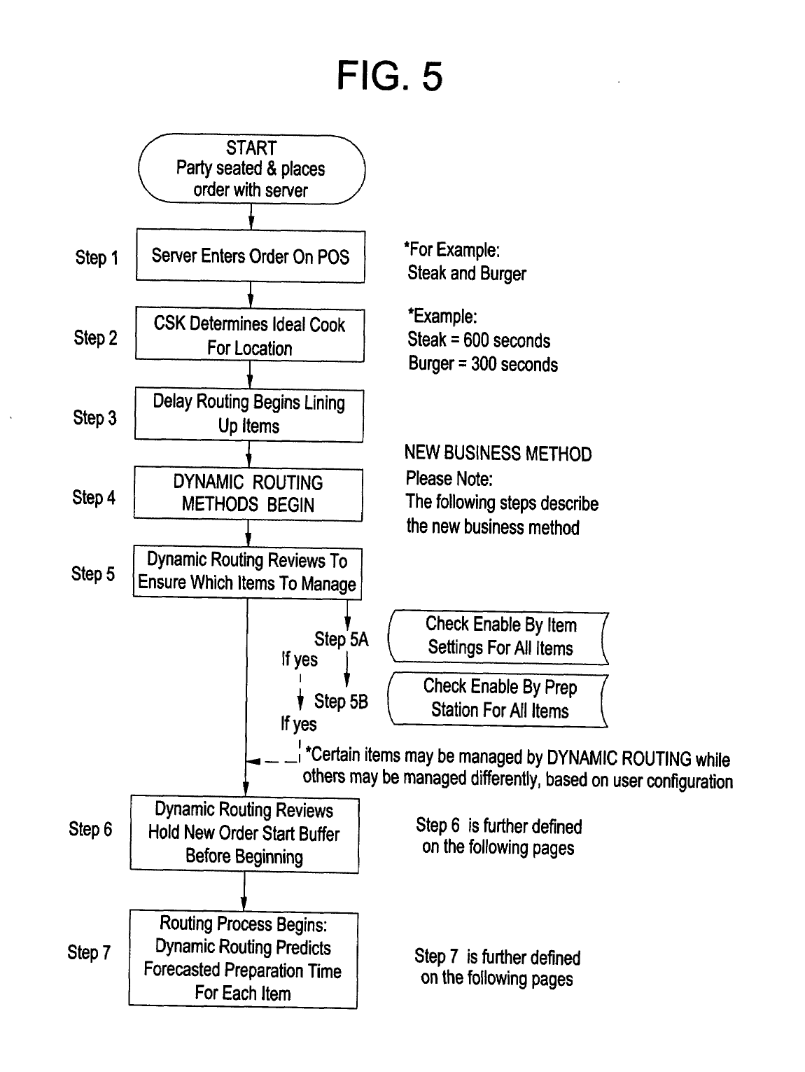

In the explanation to follow, reference is made to FIGS. 5-10 which show a flowchart of the operation of the inventive method. A party is seated and places an order with the server. The server enters the order on a point-of-sale terminal and the CSK system determines the ideal cook time for each portion of the items ordered from a resident data base. The system lines up the items on the order to fire to the appropriate prep stations based on these ideal cook times so that all items on the order will be targeted to complete the preparation process at the same time in accordance with the Delay Routing scheme of the CSK system.
1) An order is rung up on a point-of-sale terminal and recorded.
2) The CSK determines the ideal cook times for each of the items from the resident database.
3) The system lines up the items on the order to fire to the appropriate one of a plurality of prep stations based on prep station availability and these ideal cook times so that all items on the order will be targeted to complete the preparation process at the same time (Delay Routing).

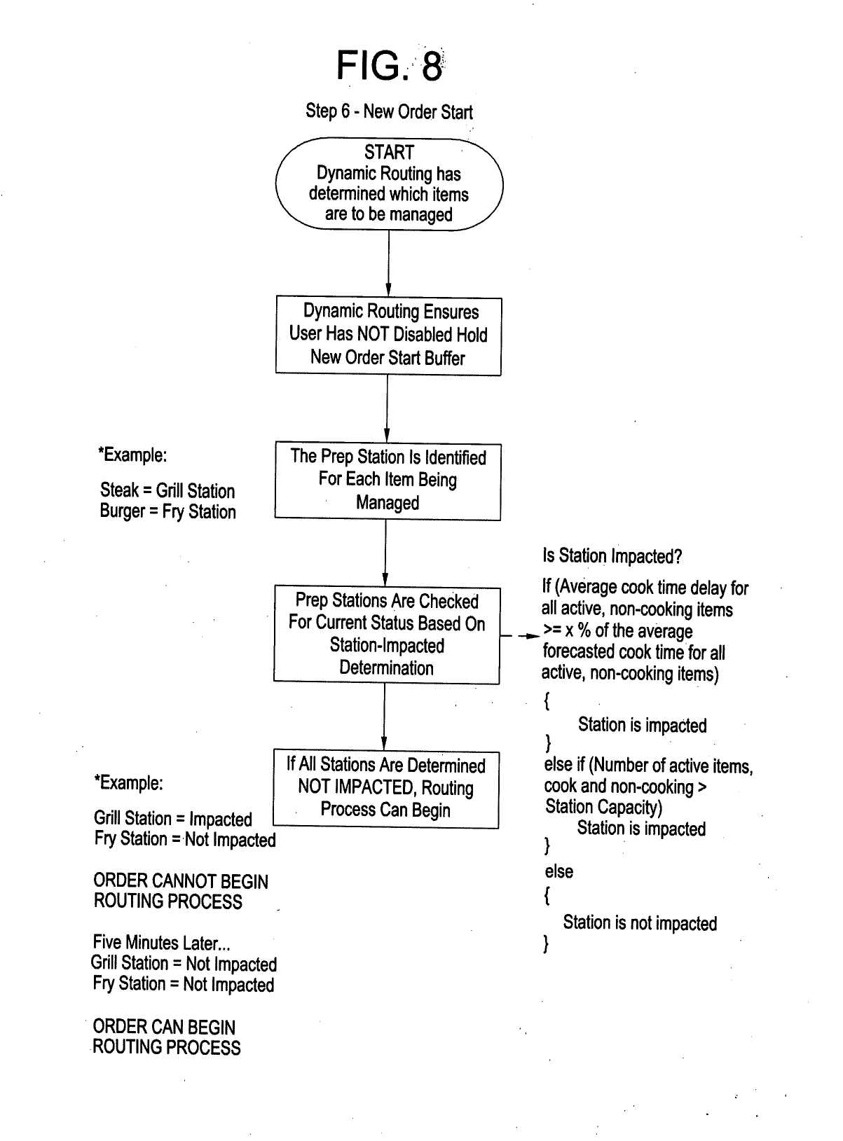

Dynamic Routing methods of the present invention are now applied to the Delay Routing timing of the CSK system. In a first aspect, Dynamic Routing determines if all items on the order are to be managed by Dynamic Routing based on the Enable By Item and Enable By Prep Station settings of the system. Dynamic Routing determines if the routing process can begin for the order based on the Hold New Order Start Buffer (see FIG. 8).
a) If the Order Start Requirement has not disabled the Hold New Order Start Buffer, then Dynamic Routing uses the Hold New Order Start Buffer to determine if the order can be started based on the current status of each of the plurality of prep stations involved in the processing of the items within that order.
b) The system takes into account the user defined Station Impacted Determination to determine if any of the prep stations is considered behind.
   Once Dynamic Routing has determined (using the Calculation Refresh Time to continuously evaluate current conditions) that the items within that order can begin routing and do not need to be held, the process continues.

With reference back to FIG. 5, Step 7, Dynamic Routing predicts the Forecasted Preparation Time of each item on the order that is to be managed by Dynamic Routing.

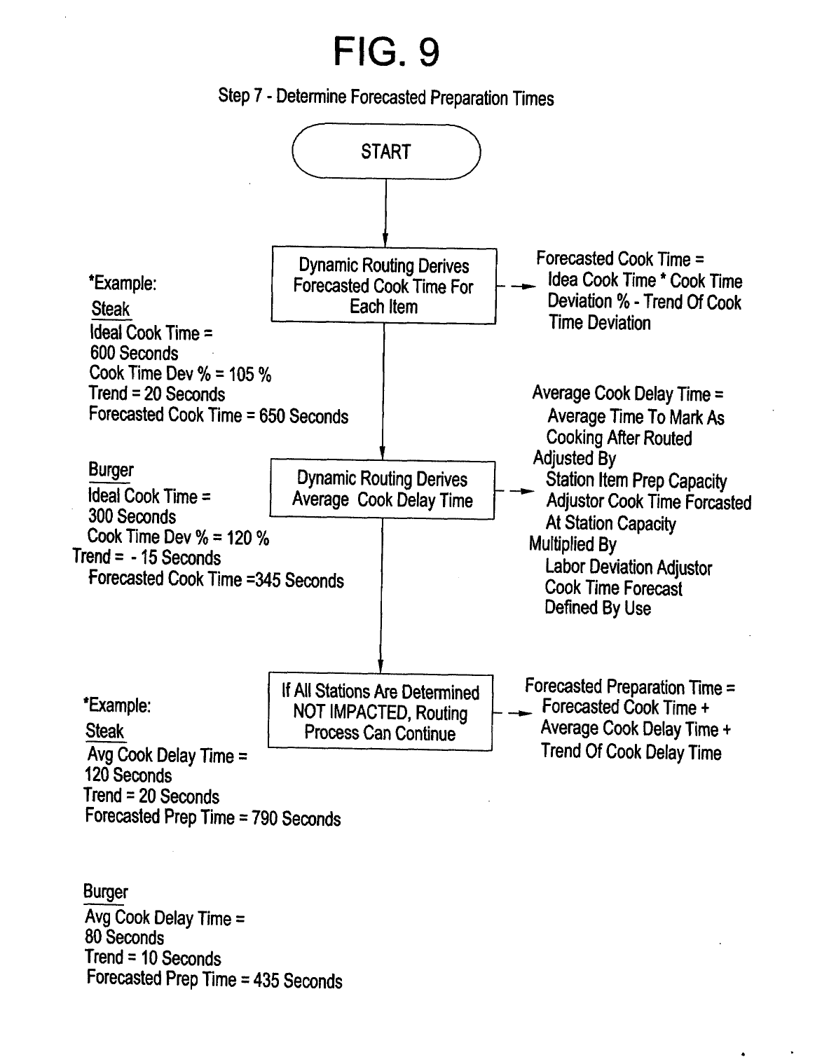

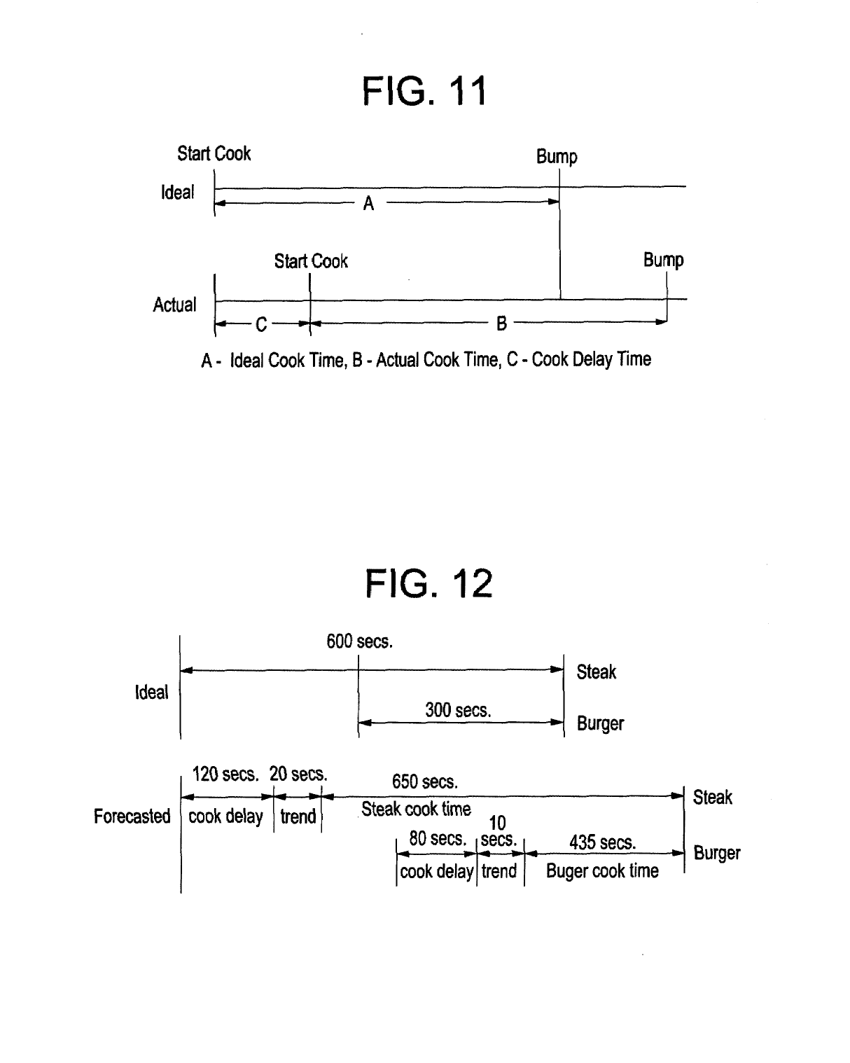

With further reference to FIG. 9:
a) Each item will be reviewed for the Cook Time Deviation Percent. The Trend of Cook Time Deviation will also be determined, with the combination of these used to derive the Forecasted Cook Time for each item on the order.
b) Each prep station affecting the order will be reviewed for the Cook Delay Time. The Trend of Average Cook Delay Time will also be determined for each prep station. These factors will be added to the Forecasted Cook Time for each item on the order to determine the Forecasted Preparation Time for each item on the order.
i) Based on system configurations, the Labor Deviation Adjustor is applied to finalize the Cook Delay Time.
ii) Based on system configurations, the Station Item Preparation Capacity Adjustor is reviewed and accounted for within the Cook Time Delay Time. See FIG. 11.

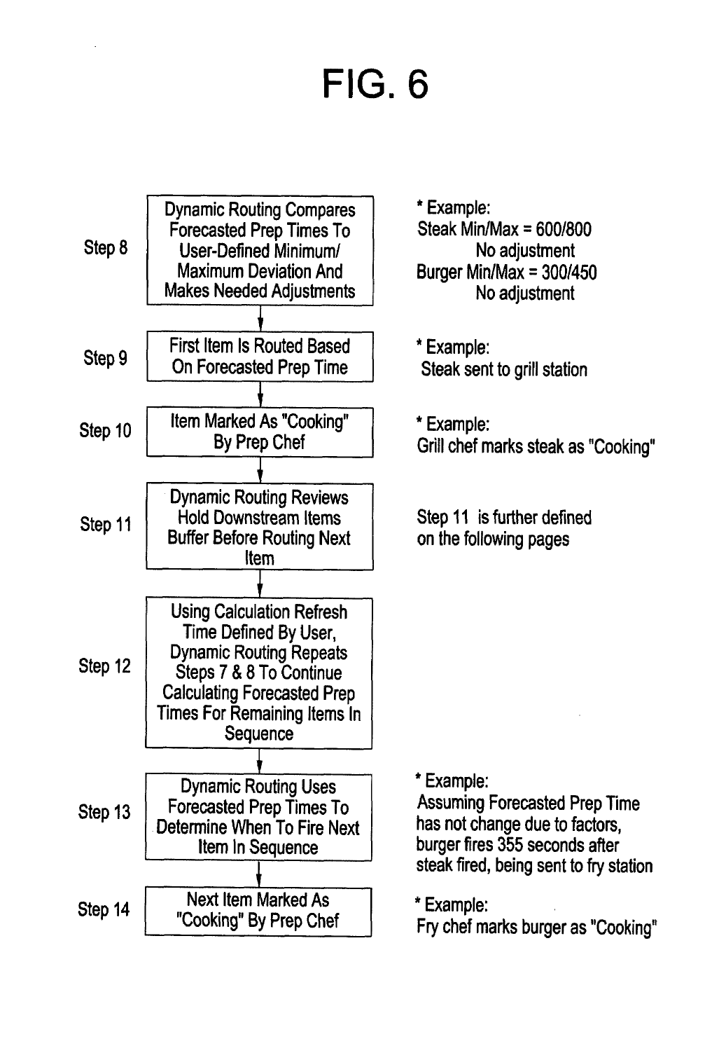

With reference to FIG. 6 and Step 8, the Forecasted Preparation Times are then compared to the user defined Minimum/Maximum Deviation to ensure the forecasted times do not need to be adjusted. Next, (Step 9) the Forecasted Preparation Times are then used to determine when to fire the first item in the sequence on that order, routing that item to its appropriate prep station to begin the preparation process for that item and the timing for the remaining items on the order. Next, (Step 10) the first item in the sequence is marked as cooking by the kitchen personnel.

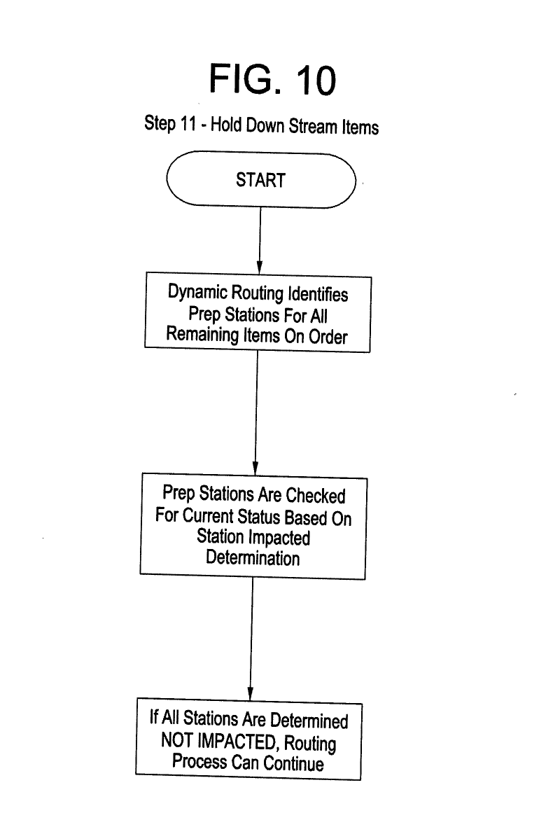

As shown in Step 11, Dynamic Routing determines if the routing process can continue for the order based on the Hold Downstream Items Buffer. With further reference to FIG. 10:
a) Dynamic Routing uses the Hold Downstream Items Buffer to determine if the remaining items on the order can continue the routing process based on the now current status of each of the prep stations involved in the processing of the remaining items within that order.
b) The system takes into account the user defined Station Impacted Determination to determine if any of the prep stations affecting those remaining items is considered behind.

Once Dynamic Routing has determined (using the Calculation Refresh Time to continuously evaluate current conditions) that the remaining items within that order can continue being routed and do not need to be held, the process continues.

With reference back to FIG. 6 and Step 12, the Calculation Refresh Time is used to continuously evaluate current conditions, Dynamic Routing continues to calculate the Forecasted Preparation Times for the remaining items in the sequence for that order—repeating Step 7 and Step 8 (FIGS. 5-6).

As shown in Step 13, the Forecasted Preparation Times are then used to determine when to fire the next item in the sequence on that order, routing that item to its appropriate prep station to begin the preparation process for that item. That item is marked as cooking by the kitchen personnel (Step 14).

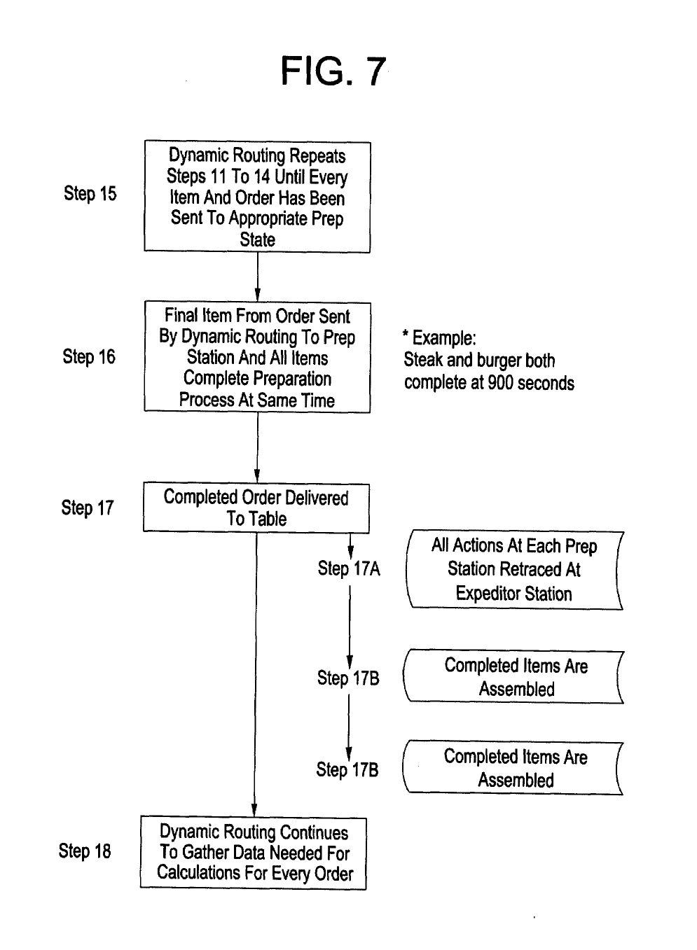

With reference to FIG. 7 and Step 15, Steps 11, 12, 13, and 14 are repeated until every item on that order has been sent to its appropriate prep station for the preparation process. Once the final item from the order is fired based on the Dynamic Routing method (Step 16), all items should complete the preparation process at the same time.

Next (Step 17), all actions at each prep station are being reflected on the expeditor station via display attributes. Restaurant personnel (runners and servers) are assembling the completed items on plates or other serving dishes for the entire order to be delivered to the table.

Finally (Step 18), the system continuously reviews the current conditions of the items and prep stations, the actions of the kitchen personnel, and all factors that can impact forecasted times to continuously provide the data that Dynamic Routing needs for calculations for every order. Data may be revised to reflect actual results accruing through practice of the method.

An example of calculations made with the Dynamic Routing Process of the present invention is as follows, with reference to FIG. 12:

Example of Calculations with the Dynamic Routing Process:

| Station A | | Station B | |
|---|---|---|---|
| Average Cook Delay Time: | 120 seconds | Average Cook Delay Time: | 80 seconds |
| Trend of Average Cook Delay Time: | +20 seconds | Trend of Average Cook Delay Time: | +10 seconds |
| Cook Time Deviation Percent: | 105% | Cook Time Deviation Percent: | 120% |
| Trend of Average Cook Time Deviation: | +20 seconds | Trend of Average Cook Time Deviation: | −15 seconds |

### Order

Steak: Ideal Cook Time of 600 seconds
Burger: Ideal Cook Time of 300 seconds
The steak is prepared by Station A and the burger is prepared by Station B.

### Steak Calculations:

### Forecasted Cook Time=Ideal Cook Time*Cook Time Deviation Percentage+Trend

### Forecasted Cook Time=600*105%+20

Forecasted Cook Time=650 seconds

### Forecasted Preparation Time=Forecasted Cook Time+Average Cook Delay Time+Trend

### Forecasted Preparation Time=650+120+20

Forecasted Preparation Time=790 seconds Burger Calculations:

### Forecasted Cook Time=Ideal Cook Time*Cook Time Deviation Percentage+Trend

### Forecasted Cook Time=300*120%+(15)

Forecasted Cook Time=345 seconds

### Forecasted Preparation Time=Forecasted Cook Time+Average Cook Delay Time+Trend

### Forecasted Preparation Time=345+80+10

Forecasted Preparation Time=435 seconds

Based upon the above disclosure, practice of the present invention results in the ability to more accurately react to the ebb and flow of kitchen meal preparation. The power of the inventive method, in a table service environment especially, is its ability to set the flow of items within a particular order through the kitchen so that they get completed at relatively the same time. Dynamic Routing of the inventive method will help ensure that the integrity of that timing and spacing remains in tact even when a kitchen is running at capacity in a very busy restaurant.

In summary:
1) Dynamic Routing improves on advanced routing methods by being forward looking and forecasting the time to prepare each of the menu items within an order based on the current capacity and conditions of individual prep stations.
2) Dynamic Routing has the ability to monitor for current status on a user defined basis (such as every 30 seconds or every 2 minutes or some time period therebetween), updating forecasted times based on real-time factors that can impact these forecasted times.
3) Dynamic Routing improves on advanced routing methods by keeping track of the status of each and every individual item within an order as it goes through the preparation process. Therefore, if one item gets behind or one prep station that is responsible for an item on that particular order get behind, the remaining items do not fire to the prep stations, keeping the balance of the order on track for all items to complete the preparation process at the same time.
4) Overall, the Dynamic Routing method encompasses every facet of the preparation process and every factor that can impact that preparation process, using advanced logic and algorithms to continuously forecast and adjust forecasted times at a very granular menu item level to protect workflow, labor efficiency, and food quality.

For a more complete understanding of the above disclosure, the following list contains terms and concepts used in describing the process and calculations for the Dynamic Routing method. When not already defined in the sections above, these terms and concepts are defined below.

### Ideal Cook Time

The “perfect world” cook time of a given item, which is configured in the resident database (most often the point-of-sale system, but can also be configured in the CSK). This time is fixed and is how long it takes to prepare that item in a “vacuum”. This value is represented as a number of seconds in the CSK.

### Actual Cook Time

The time it actually takes to cook a given item, which can be more or less than the Ideal Cook Time based on current conditions. This is derived by actual activity at the prep station, where the kitchen personnel marks an item as cooking and then marks that item as prepared. This value is represented as a number of seconds in the CSK.

### Average Actual Cook Time

The average Actual Cook Time for a given prep station over a given span of time as defined by the user. This value is represented as a number of seconds in the CSK.

### Cook Time Deviation

In a “perfect world,” the Ideal Cook Time and the Actual Cook Time would be the same, however factors as described above often cause these times to differ. The Cook Time Deviation is the difference between the Ideal Cook Time and the Actual Cook Time. This value can be represented by a number of seconds in the CSK, which can be a positive or negative number depending on whether the Actual Cook Time is less than or greater than the Ideal Cook Time. Or this value can be represented by a percentage value of the Ideal Cook Time, which can be above or below 100% depending on whether the Actual Cook Time is less than or greater than the Ideal Cook Time.

Calculations are as follows:

Cook Time Deviation=Actual Cook Time—Ideal Cook Time

Cook Time Deviation Percent=(Actual Cook Time−Ideal Cook Time)/Ideal Cook Time

### Cook Delay Time

In a “perfect world” each item would begin being prepared as soon as it is routed to a prep station. The Cook Delay Time is the time it actually takes the kitchen personnel to begin preparing the item, derived by the time that elapses between an item being routed a prep station and the item being marked as cooking by the kitchen personnel. This value is represented as a number of seconds in the CSK.

### Actual Preparation Time

In a “perfect world” each item would begin being prepared as soon as it is routed to a prep station and would then be finished cooking based on the Ideal Cook Time. The Actual Preparation Time is the time it actually takes to the kitchen personnel to begin preparing the item (Cook Delay Time) plus the time it actually takes to cook the item (Actual Cook Time). This value is represented as a number of seconds in the CSK.

### Minimum/Maximum Deviation

In a “perfect world” the Ideal Cook Time and the Actual Cook Time would be the same, however factors as described above often cause these times to differ. The Minimum/Maximum Deviation allows the user to define the minimum and maximum deviation from the Ideal Cook Time that will be allowed in the calculations performed by Dynamic Routing based on these factors. If any forecasted times, as described below, go above or below the Minimum/Maximum Deviation, that forecasted time will be adjusted back to the defined minimum or maximum value.

For example:

| | Minimum Forecasted | Maximum Forecasted |
|---|---|---|
| Ideal Cook Time | Cook Time | Cook Time |
| 1 | 1 | 1 |
| 2 | 2 | 2 |
| 3 | 2 | 4 |
| 4 | 4 | 6 |
| 5 | 4 | 6 |
| 10 | 8 | 12 |
| 20 | 15 | 25 |
| 30 | 22 | 38 |

### Trend of Cook Time Deviation

The Dynamic Routing method puts checks and balances in place to take into account short term trends (spikes) that may not be captured by averages, and to ensure that anomalies do not negatively impact forecasts. Therefore, the process takes into account averages, trends, and the Minimum/Maximum Deviation. The Trend of Cook Time Deviation is derived by taking the average of the Cook Time Deviation over a given span of time as defined by the user. This value is most often represented as a number of seconds in the CSK, but could be represented as a percentage. This value could be a positive or negative number, or less than or greater than 100%, based on a positive or negative trend.

### Trend of Cook Delay Time

The Dynamic Routing method puts checks and balances in place to take into account short term trends (spikes) that may not be captured by averages, and to ensure that anomalies do not negatively impact forecasts. Therefore, the process takes into account averages, trends, and the Minimum/Maximum Deviation. The Trend of Cook Delay Time is derived by taking the average of the Cook Delay Time over a given span of time as defined by the user. This value is most often represented as a number of seconds in the CSK, but could be represented as a percentage. This value could be a positive or negative number, or less than or greater than 100%, based on a positive or negative trend.

### Forecasted Cook Time

The forecasted time to cook a given item for a given station based on factors which take into account current conditions. The Forecasted Cook Time is derived by adjusting the Ideal Cook Time by the Actual Cook Time and the Cook Time Deviation. This value is represented as a number of seconds in the CSK.

Calculation is as follows:

Forecasted Cook Time=Ideal Cook Time*Cook Time Deviation Percent+Trend of Cook Time Deviation

### Forecasted Preparation Time

The forecasted time to fully prepare a given item for a given station based on factors which take into account current conditions. The Forecasted Preparation Time is derived by adjusting the Forecasted Cook Time by the average Cook Delay Time over a given span of time as defined by the user (“Average Cook Delay Time”). This value is represented as a number of seconds in the CSK.

Calculation is as follows:

Forecasted Preparation Time=Forecasted Cook Time+Average Cook Delay Time+Trend of Average Cook Delay Time

### Calculation Refresh Time

The Dynamic Routing method includes refreshing the forecasted times based on all factors that impact the Dynamic Routing process every X number of seconds, where X is defined by the user (such as every 30 seconds or every 2 minutes).

### Labor Deviation Adjustor

Because labor is another factor that can impact the preparation process, the user can choose to apply an adjustment to forecasted times based on the amount and quality of labor present to man a particular prep station at a given time. Kitchen personnel are each assigned a rating (A, B, or C) and then must clock in and out at the prep station. Based on the number of personnel and the ratings of those personnel that are clocked in at that prep station, the user can automatically apply a positive or negative percentage to the Cook Delay Time.

### Station Item Preparation Capacity Adjustor

An adjustment factor that a user can choose to add to the Cook Delay Time, which is represented as a number of seconds, based on the actual number of items that can physically fit and be processed on the equipment used at a particular prep station at any one time (“Station Capacity”). For stations that prepare a mix of items with significantly different physical dimensions, the user determines an average food mix at that prep station to assign the Station Capacity in the resident database. It is assumed that any items above the Station Capacity will be required to wait until an item that is in the preparation process is completed before these items can begin the preparation process at that station.

### Station Impacted Determination

The status of a given prep station is used throughout the Dynamic Routing method. For instance, if a prep station is behind schedule, the Dynamic Routing method may hold up new orders or wait to fire additional items from an order. The Dynamic Routing method determines if a station is being impacted to the point that orders or items should be held up on a temporary basis. The Station Impacted Determination is derived based on either of two calculations:

Average Cook Delay Time for all active, non-cooking items>=the average of the Forecasted Cook Time for all active, non-cooking items Number of active items, both cooking and non-cooking>Station Capacity

### Hold New Order Start Buffer

A condition that causes the Dynamic Routing method to wait to fire any items from a new order because one of the prep stations that is involved in the processing of that order is impacted, which is determined based on the Station Impacted Determination. Once all stations that are involved in the processing of that order are no longer impacted (with a check based on the Calculation Refresh Time), then the Dynamic Routing method will begin firing items from the new order.

### Hold Downstream Items Buffer

A condition that causes the Dynamic Routing method to wait to fire additional items from an order because one of the prep stations that is involved in the processing of that order has become impacted, which is determined based on the Station Impacted Determination. Once all stations that are involved in the processing of the remaining items on that order are no longer impacted (with a check based on the Calculation Refresh Time), then the Dynamic Routing method continues firing items from the order.

As a highly configurable system, the CSK offers users many options when determining how to route items and orders within the kitchen. Some of these options were described above. A few of the additional user definable options which hold importance as it relates to the Dynamic Routing method are described below.

### Enable by Item

This option enables the user to apply the Dynamic Routing method logic only when an order contains certain items.

### Enable by Prep Station

This option enables the user to apply the Dynamic Routing method logic only when an order contains items that will be routed to certain prep stations.

### Order Start Requirement

This option allows the user to disable the Hold New Order Start Buffer. When the Hold New Order Start Buffer is disabled, the system will begin routing the first item from a new order as soon as the order is received.

### Use Time Span or Meal Period

This option determines whether averages are calculated based on the current meal period or a sliding window of time as defined by a user definable number of minutes to look backwards, such as the last 5 minutes.

### Basis for Priority and Rush Status

This option determines whether an item's Priority and Rush statuses are based on the Ideal Cook Time or the Forecasted Cook Time.

### Weights

To give the user even more control, the experienced in-store manager can affect the Dynamic Routing method in real-time by responding to current conditions by adjusting the Weights of the factors that are used to determined Forecasted Cook Time and Forecasted Preparation Time. For example, if the store manager makes a determination that the Cook Delay Time is impacting the Forecasted Preparation Time more than what the system calculation is reflecting or more than the Cook Time Deviation, the manager can put a higher weight on the Cook Delay Time, making this value more important in the calculation that the Dynamic Routing method is using to route items. Weights adjustments can be made at any time by the in-store manager using the in-store tool called CSK Console.

The present invention has been disclosed in terms of an example of how it may be practiced using a computerized system and software created to facilitate its operation. As should be understood by those of ordinary skill in the art, the present invention may also be practiced without the use of computers and software by merely undertaking the sequence of steps identified in detail in FIGS. 5-10.

As such, an invention has been disclosed in terms of a preferred embodiment thereof which fulfills each and every one of the objects of the invention as set forth above, and provides a new and useful method of dynamically routing food items through a restaurant kitchen of great novelty and utility.

Of course, various changes, modifications and alterations in the teachings of the present invention may be contemplated by those of ordinary skill in the art without departing from the intended spirit and scope thereof.

As such, it is intended that the present invention only be limited by the terms of the appended claims.

1. A method of dynamically routing food items through a restaurant kitchen so that preparation of said food items is completed concurrently, including the steps of:
a) recording a food order composed of a plurality of food items;
b) determining ideal cooking time for each food item;
c) calculating when cooking of each food item must commence such that each food item is completely cooked at substantially the same time;
d) commencing cooking of a first food item;
e) waiting a calculated time period, then commencing cooking of a second food item;
f) cooking said first and second food items until they are completely cooked at substantially the same time of completion; and
g) serving said first and second food items.

2. The method of claim 1, before said step of commencing cooking of said first food item, further including the step of checking current capacity of a prep station where said food items will be prepared to determine when commencement of cooking of said first food item may occur.

3. The method of claim 2, wherein said checking step is repeated periodically until it is determined that said prep station is available to cook said first food item.

4. The method of claim 3, wherein said checking step is repeated every 30 seconds.

5. The method of claim 3, wherein said checking step is repeated every 2 minutes.

6. The method of claim 1, wherein said calculated time period is recalculated periodically before commencing preparation of said second food item.

7. The method of claim 6, wherein recalculation of said calculated time period includes the step of checking cooked status of said first food item to determine whether cooking of said first food item is on schedule.

8. The method of claim 7, wherein if cooking of said first food item is behind schedule, further including the step of delaying commencement of cooking of said second food item for a time period commensurate with a time period by which cooking of said first food item is behind schedule.

9. The method of claim 7, wherein said checking step is repeated periodically.

10. The method of claim 9, wherein said checking step is repeated approximately every 30 seconds.

11. The method of claim 1, after said serving step, gathering data concerning actual cook times for completed food items.

12. The method of claim 11, after said gathering step, updating cook times previously employed in said determining step to reflect actual data from cooking food items.

13. The method of claim 1, wherein before said serving step, completed food items are assembled on one or more serving dishes.

14. The method of claim 2, wherein at least two prep stations are provided.

15. The method of claim 14, further including the step of, before said commencing step, checking current capacity of all prep stations and choosing a first available prep station for preparation of said first food item.

16. A method of dynamically routing food items through a restaurant kitchen so that preparation of said food items is completed concurrently, including the steps of:
a) recording a food order composed of a plurality of food items;
b) determining ideal cooking time for each food item;
c) calculating when cooking of each food item must commence such that each food item is completely cooked at substantially the same time;
d) periodically checking current capacity of a plurality of prep stations where said food items may be prepared to determine when commencement of cooking of said first food item may occur at one of said prep stations;
e) commencing cooking of a first food item at a chosen prep station;
f) waiting a calculated time period, then commencing cooking of a second food item;
g) cooking said first and second food items until they are completely cooked at substantially the same time of completion; and
h) assembling and serving said first and second food items.

17. The method of claim 16, wherein said checking step is repeated every 30 seconds to 2 minutes.

18. The method of claim 16, wherein said calculated time period is recalculated periodically before commencing preparation of said second food item.

19. The method of claim 18, wherein recalculation of said calculated time period includes the step of checking cooked status of said first food item to determine whether cooking of said first food item is on schedule.

20. The method of claim 19, wherein if cooking of said first food item is behind schedule, further including the step of delaying commencement of cooking of said second food item for a time period commensurate with a time period by which cooking of said first food item is behind schedule.

21. The method of claim 16, after said serving step, gathering data concerning actual cook times for completed food items.

22. The method of claim 21, after said gathering step, updating cook times previously employed in said determining step to reflect actual data from cooking food items.

23. The method of claim 16, wherein said recording step is undertaken employing a memory of a computer.

24. The method of claim 23, wherein said calculating and periodically checking steps are undertaken employing a software program programming said computer to so calculate and periodically check.

25. The method of claim 16, wherein ideal cooking time for each food item is stored in a memory section of a computer.

26. The method of claim 22, wherein said updating step is undertaken by inputting data into a memory section of a computer.
